(19) United States
(12) Patent Application Publication
(10) Pub. No.: US 2026/0236235 A1
(43) Pub. Date: Aug. 13, 2026

(54) ARTIFICIAL INTELLIGENCE FOR SYNTHETIC DATA GENERATION

(71) Applicant: International Business Machines Corporation, Armonk, NY (US)

(72) Inventors: Yuan Yuan Ding, Shanghai (CN); Shi Yun Liang, Shanghai (CN); Zhong Fang Yuan, Xi'an (CN); Tong Liu, Xi'an (CN)

(73) Assignee: International Business Machines Corporation, Armonk, NY (US)

(21) Appl. No.: 19/050,249

(22) Filed: Feb. 11, 2025

(51) Int. Cl. G06F 8/35; G06F 8/36; G06N 20/00

(52) U.S. Cl. CPC G06F 8/35; G06F 8/36; G06N 20/00

(57) ABSTRACT

According to a technique of synthetic data generation, natural language workflow prompt is generated that includes instructions to generate multiple versions of workflow code for generating synthetic data. The generated workflow prompt is inputted into a generative machine learning model such that, in response, the generative machine learning model produces multiple versions of the workflow code for generating synthetic data. Multiple versions of the workflow code are inputted into at least one evaluator machine learning model such that, in response, the at least one evaluator machine learning model selects one of the multiple versions of the workflow code. Synthetic data is generated by executing the selected workflow code and stored in data storage.

### BACKGROUND OF THE INVENTION

The present invention relates in general to data processing, in particular, to synthetic data generation, to machine learning models, to artificial intelligence, and to agentic artificial intelligence.

### SUMMARY OF THE INVENTION

In one or more embodiments of a computer-implemented technique of synthetic data generation, natural language workflow prompt is generated that includes instructions to generate multiple versions of workflow code for generating synthetic data. The generated workflow prompt is inputted into a generative machine learning model such that, in response, the generative machine learning model produces multiple versions of the workflow code for generating synthetic data. Multiple versions of the workflow code are inputted into at least one evaluator machine learning model such that, in response, the at least one evaluator machine learning model selects one of the multiple versions of the workflow code. Synthetic data is generated by executing the selected workflow code and stored in data storage.

### BRIEF DESCRIPTION OF THE DRAWINGS

FIG. 1A is a high-level block diagram of an exemplary data processing environment in accordance with one or more embodiments;

FIG. 1B depicts a more detailed view of an exemplary synthetic data generation tool in accordance with one or more embodiments;

FIG. 2 depicts a more detailed view of an exemplary synthetic data generation tool in accordance with one or more embodiments; and

FIG. 3 is a high-level logical flowchart of an exemplary process for synthetic data generation in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as synthetic data generation tool 200. In addition to synthetic data generation tool 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and synthetic data generation tool 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

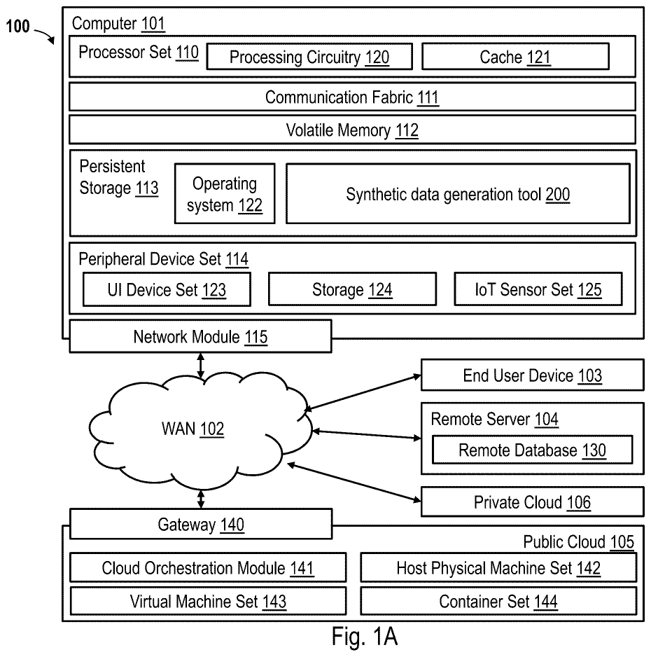

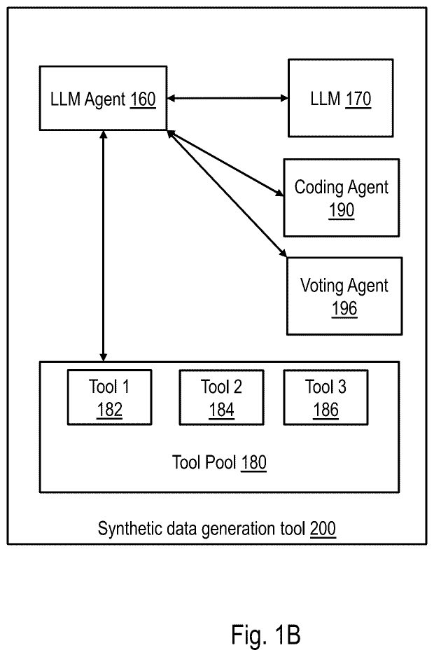

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1A. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid state storage devices.

Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (eud) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Cloud computing services and/or microservices (not separately shown in FIG. 1A): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the Internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Those of ordinary skill in the art will appreciate that the architecture and components of a data processing environment can vary between embodiments. Accordingly, the exemplary computing environment 100 given in FIG. 1A is not meant to imply architectural limitations with respect to the claimed invention.

Referring now to FIG. 1B, a more detailed view of an exemplary synthetic data generation tool 200 is depicted in accordance with one or more embodiments. FIG. 1B is an example diagram illustrating an operation of a large language model (LLM) agent 160 that in various embodiments is part of the synthetic data generation tool 200. As shown in FIG. 1B, the LLM agent 160 operates in conjunction with an LLM 170, a coding agent 190, and/or a voting agent 196. The LLM 170, the coding agent 190, and the voting agent 196 accept prompt inputs and perform tasks in response to prompt inputs based on instructions provided in the prompt inputs. Thus, the LLM agent 160 calls the LLM 170, the coding agent 190, and/or the voting agent 196 with a prompt telling the LLM 170, the coding agent 190, and/or the voting agent 196 what the task is and what kind of tools are available to accomplish the task. The LLM agent 160 lets the LLM 170, the coding agent 190, and/or the voting agent 196 make the decision on which of these tools to use and what are the relevant parameters for calling those tools. The LLM 170, the coding agent 190, and/or the voting agent 196 can generate a decision of which tools to utilize, but it is the LLM agent 160 that executes the tools based on this LLM 170/coding agent 190/voting agent 196 decision. The LLM 170 generates text and often does not interact directly with the tools.

The LLM agent 160 executes the tools, obtains the tool results, and adds the results to a prompt to call the LLM 170 again, i.e., to let the LLM 170 give a decision and invoke any additional tools that may be needed in an iterative manner until the decision of the LLM 170 is a FINAL_ANSWER, which means the process can be finished.

As noted above, the LLM agent 160 needs to prepare the prompt before calling the LLM 170, the coding agent 190, and/or the voting agent 196. In accordance with the illustrative embodiments, the LLM agent 160 is an artificial intelligence (AI) agent, meaning a system or program that is capable of autonomously performing tasks on behalf of a user or another system by designing its workflow and utilizing available tools. AI agents can encompass a wide range of functionalities beyond natural language processing including decision-making, problem-solving, interacting with external environments and executing actions. These AI agents can be deployed in various applications to solve complex tasks in various enterprise contexts from software design and IT automation to code-generation tools and conversational assistants. The AI agents use the advanced natural language processing techniques of large language models (LLMs) to comprehend and respond to user inputs step-by-step and determine when to call on external tools.

AI agents may comprise memory which allows storage of past interactions and decisions. AI agents use tool calling on the backend to obtain up-to-date information, optimize workflows, and create subtasks autonomously to achieve complex goals.

In this process, the autonomous AI agent, i.e., LLM agent 160, learns to adapt to user expectations over time. The LLM agent's ability to store past interactions in memory and plan future actions encourages a personalized experience and comprehensive responses. This tool calling can be achieved without human intervention and broadens the possibilities for real-world applications of these AI systems. The approach that AI agents take in achieving goals set by users is comprised of these three stages: (1) goal initialization and planning, (2) reasoning using available tools, and (3) learning and reflection. Although AI agents are autonomous in their decision-making processes, they require goals and environments defined by humans.

AI agents use feedback mechanisms, such as other AI agents and human-in-the-loop (HITL), to improve the accuracy of their responses. AI agents may also be referred to as LLM agents, such as LLM agent 160, and in some instances implement a Reasoning and Action (ReAct) architecture as a form of Chain-of-Thought prompting. In at least some instances, the LLM agent 160 implements Tree-of-Thought prompting. The AI agents include goal-based agents, utility-based agents, and learning agents.

The LLM agent 160 uses a tools-related prompt to prompt the LLM 170 to perform its decisions and ultimately obtain a final result. A tools-related prompt provides the descriptions of a list of tools available as stored in the tool pool 180. The depicted example in FIG. 1B shows three tools (i.e., tool 1 182, tool 2 184, and tool 3 186), but in practice it should be appreciated that such tool pool 180 may store more than three tools, e.g., may list hundreds or even thousands of tools available to the LLM 160 for performing the given task and thus, the specification of the available tools in the tools related prompt may represent a large portion of the prompt.

In the realms of data science and machine learning, the generation of synthetic data has become an essential component for building robust data models. Synthetic data serves multiple purposes, including augmenting limited datasets, preserving privacy, and enabling the testing of algorithms under various scenarios. Traditionally, Generative Adversarial Networks (GANs) have been the cornerstone for synthetic data generation. GANs operate by simulating the distribution of real data and then generating new samples through a process of random combination.

One of the primary challenges with GAN-based synthetic data generation is the lack of diversity in the generated data. Because GANs rely on the distribution of the existing dataset, GANs are inherently constrained by the characteristics of the original data, often resulting in synthetic datasets that are highly repetitive and lack the variability needed for comprehensive model training. In practical scenarios including sparse datasets, the synthetic data generated by GANs can exhibit significant redundancy, limiting its effectiveness.

The development of large language Models (LLMs) has opened the possibility of using LLMs to generate synthetic data. However, a significant limitation of LLMs is the constraint imposed by token limits. LLMs are designed to generate text within a finite number of tokens, making production of a large volume of data in a single pass difficult. While token limits may not impose a meaningful restriction on generating small-scale datasets, token limits make use of LLMs challenging when attempting to generate large datasets or multi-table datasets.

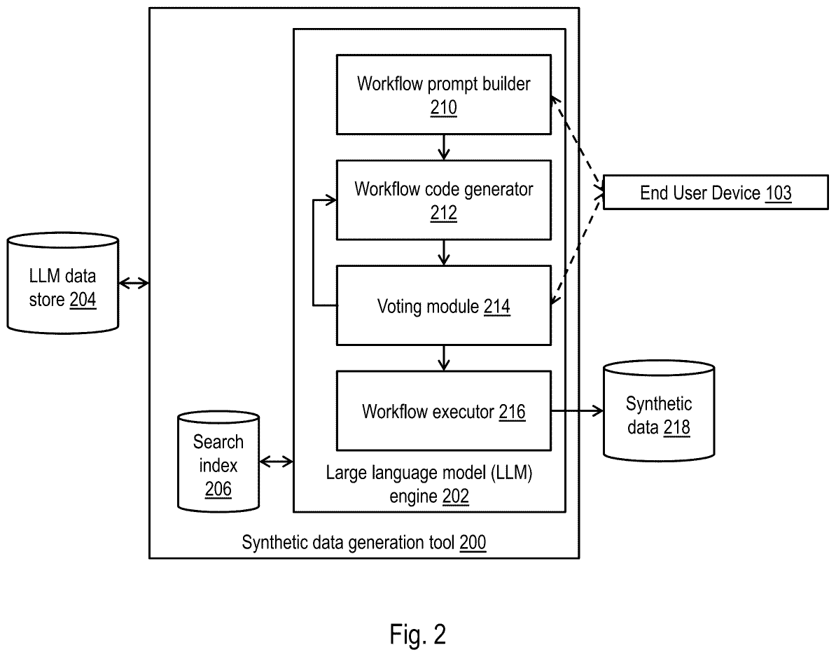

Referring now to FIG. 2, a more detailed view of an exemplary synthetic data generation tool 200 is depicted in accordance with one or more embodiments. In the illustrated example, synthetic data generation tool 200 includes a large language model (LLM) engine 202, which, as known in the art, can perform a number of functions on natural human languages, including analyzing, translating, summarizing, interpreting, and generating natural human language text, as well as processing other forms of structured and unstructured data. LLM engine 202 acquires increasing proficiency at these tasks by applying deep learning to textual information and data (e.g., websites, documentation, technical and other literature, reference materials, blog posts, procedures, datasets, etc.) in a LLM data store 204, which can include private datasets and/or public datasets (including Internet-accessible data) accessible in computing environment 100. LLM engine 202 typically maintains a search index 206 of information referenced in LLM data store 204 to facilitate rapid access. LLM engine 202 in various embodiments performs one or more of the same tasks as the LLM agent 160 that was described above with respect to FIG. 1B.

Synthetic data generation tool 200 additionally includes a workflow prompt builder 210, which can be implemented as part of LLM engine 202 and/or with supplemental software code. Workflow prompt builder 210 can be employed to generate natural language textual workflow prompts that can initiate the automated production of workflow code capable of generating a desired quality and quantity of synthetic data.

Workflow code is a set of programmatic instructions that define, orchestrate, and automate sequences of tasks, operations, or decision-making processes within a system. Unlike general-purpose programming code, which focuses on implementing algorithms and data structures, workflow code primarily specifies execution logic, dependencies, and interactions between components or services to achieve a defined business or computational workflow

Key distinctions between “workflow code” and regular programming code are that workflow code:
1. Focuses on process orchestration—the workflow code defines the execution flow rather than implementing core computational logic.
2. Encapsulates dependencies and transitions—the workflow code specifies conditions under which tasks execute, including sequencing, branching, and error handling.
3. Often integrates external services or components—the workflow code may call APIs, trigger actions in distributed systems, or coordinate multi-agent interactions.

In at least some embodiments, processing by workflow prompt builder 210 is initiated in response to a user input, for example, received from an end user device 103. A user working at end user device 103 engages a user interface generated by the synthetic data generation tool 200 that is presented via the end user device 103, e.g., that is displayed on a display screen of the end user device 103. The user uses an input device such as a microphone, mouse, keyboard, touch screen, etc. to engage the user interface and to initiate the use of the synthetic data generation tool 200. The user interface allows the user to customize details about the type of synthetic data to be generated and/or details about the tools that are to be used by the synthetic data generation tool 200 to generate synthetic data. The details about the tools include in various embodiments details such as number of the multiple coding agents to initiate and use, types of coding agents to initiate and use, number of the voting agents to initiate and use, etc. The types of coding agents and/or voting agents to use may be indicated by different base generative ML models that are trained to perform code-related tasks according to various embodiments. The different types of coding agents may have their differences based on different internal structure of the generative model and/or different types or sets of training data that were used, and/or different training tasks that were used during their training. A user may use the user interface to choose more coding agents and/or voting agents in the pursuit of a higher-quality program to be selected and higher quality synthetic data that is produced. On the other hand, a user may use the user interface to choose less coding agents and/or voting agents in the pursuit of cost savings, due to necessary costs for engaging and/or operating a code-related LLM.

Additionally, via the user interface a user is able to provide information to the tool 200 about the type of synthetic data that is to be generated in the process. In some instances, a user uploads a sample of data for analysis by the tool 200 so that the tool 200 can automatedly determine various data features to use as one or more patterns for synthetic data to be generated. In other instances, a user manually inputs the target data features so that no data analysis is necessary by the synthetic data generation tool 200. The workflow prompts generated by workflow prompt builder 210 can be ingested by a workflow code generator 212, which can also be implemented as part of LLM engine 202 and/or with supplemental software code. In at least some embodiments, workflow code generator 212 can implement multiple coding agents to generate, review, and improve workflow code. These coding agents can be, for example, simulated subject matter experts in a given field of endeavor. Coding agents are artificial intelligence (AI) agents that use a generative machine learning model such as an LLM as its brains but then has additional algorithms and tools layered on top to allow the generative model to perform various tasks. The coding agents access tools to help them achieve computer programming-related (i.e., coding) tasks. Agentic AI refers to artificial intelligence capable of making decisions, planning, and adapting to new information in real time. AI agents learn and enhance their performance through feedback, utilizing advanced algorithms and sensory inputs to execute tasks and engage with their environments. In various embodiments, the coding agents themselves have received ML training to perform code-related tasks and/or access layers of algorithms or tools that can perform code-related tasks in response to receiving natural language instructions from the LLM brain of the coding agent.

In at least some embodiments, workflow code generator 212 can implement each of the coding agents with a tree of thoughts (TOT) pipeline. In at least some embodiments, each of the coding agents can collaboratively (i.e., with input from the other coding agent(s)) and iteratively refine a respective proposed version of workflow code.

Tree of thoughts (ToT) is a framework designed to enhance the reasoning capabilities of generative machine learning models such as LLMs. The ToT approach simulates human cognitive strategies for problem-solving, enabling LLMs to explore multiple potential solutions in a structured manner, akin to a decision tree's branching paths in which steps are in a hierarchy and a respective step in one hierarchy level can lead to multiple possible next steps in one or more lower hierarchy levels. The tree of thoughts (ToT) has some overlap with chain of thoughts (CoT) framework as they both serve as conceptual algorithms for understanding the organization and progression of text generation in language models (LMs) such as generative pretrained transformers (for example, GPT-3 and GPT-4). These prompting techniques are a part of prompt engineering, which involves crafting inputs (prompts) to effectively guide generative language models in generating preferred outputs.

Tree of thoughts prompting is a framework that operates on the model's ability to generate text hierarchically, with a central topic or idea leading to branching subtopics and details. This approach mirrors how a model can expand on a specific prompt by generating increasingly specific and related text, similar to a tree structure. It allows for lookahead and tree search strategies, where the model can explore multiple branches before committing to a path, making it suitable for general problem-solving and scenarios requiring complex decision-making. This method incorporates common sense reasoning and heuristics to evaluate the quality of each branch. The self-consistency mechanism is employed to provide reliable evaluations by prompting the model multiple times.

Chain of thought prompting in contrast corresponds to the model's capacity to generate text in a linear, left-to-right fashion, where each subsequent token is directly influenced by the preceding tokens. This sequential progression reflects a simpler, more straightforward approach to text generation.

ToT's hierarchical nature makes it suitable for tasks requiring detailed exploration of multiple solutions, such as reinforcement learning scenarios, where backtracking and alternative strategies are crucial. In practical applications, APIs for generative language models, including GPT-3 and GPT-4, use prompting techniques such as ToT and CoT to enhance their performance in diverse tasks, from creative writing to complex problem-solving to synthetic data generation. Prompt engineering continues to evolve, providing powerful tools for harnessing the capabilities of advanced transformers in language models.

Tree of thoughts works by guiding LLMs through a series of reasoning steps, where each step can branch into multiple paths, allowing the model to backtrack or explore alternative strategies as needed. For example, solving a sudoku puzzle might guide the model to explore different number placements in a trial-and-error fashion. The model then backtracks when a number leads to a contradiction and the model tries a different number until the puzzle is solved. This mimics the human approach to problem-solving, where multiple solutions are considered and discarded if found incorrect. ToT is a sophisticated framework designed to enhance the problem-solving capabilities of LLMs by structuring their reasoning in a manner analogous to human cognitive processes. The framework is composed of four key components:
a. (A) Thought decomposition: The ToT framework explicitly breaks a problem into smaller, manageable steps called thoughts, which are pieced together to form a solution. Each thought should be the right size—not too large to handle or too small to be useful. For example, if you are planning a trip, a thought might involve deciding on a travel destination first, then choosing the best mode of transportation and finally picking a place to stay. In a mathematical problem, a thought might be a single equation line or a concise concept explanation. This way, the problem is broken down into key steps that are easy to tackle and evaluate individually. The decomposition depends on the nature of the problem, making sure that thoughts are both significant and feasible for evaluation.
b. (B) Thought generation: After defining what constitutes a thought, the next step is to determine how these thoughts are generated. The framework proposes two primary techniques.
c. (C) Sampling: This technique involves generating several thoughts independently by using the same prompt. It works best when the thought space is rich and diverse, as independently generated thoughts are less likely to be duplicated. For example, in creative writing, multiple independent plot ideas might be generated.
d. (D) Proposing: This technique sequentially generates thoughts using a “propose prompt.” Each thought is built upon the previous one, which helps avoid duplication in more constrained thought spaces. For example, in logical problem-solving, each step builds on the previous one to help ensure consistency and progress.

Once thoughts are generated, the thoughts must be evaluated to help ensure progress toward a solution. The framework employs 2 strategies for this purpose:
a. Value: This strategy involves assigning a scalar value (for example, a rating from 1-10) or a classification (for example, sure, likely, or impossible) to each state. This helps indicate the value's quality or likelihood of leading to a solution. This method allows for a quantitative assessment of each thought's potential.
b. Vote: This strategy compares different solutions and selects the most promising one. Voting is particularly useful for tasks where the quality of a solution is subjective or hard to quantify, such as in creative writing, strategic planning, or code generation. Multiple evaluations combine to determine the best path forward.

Some embodiments of a ToT component involve the search algorithm used to navigate through the solution space. The framework typically employs 2 fundamental algorithms:
a. Breadth-first search (BFS): This algorithm explores all possible branches at each level before moving deeper into the tree. This algorithm makes sure that all potential solutions are considered equally, making the algorithm useful for problems where the shortest path or shallowest solution is preferred. For example, in a puzzle game, BFS would check all immediate moves before considering subsequent ones.
b. Depth-first search (DFS): This algorithm explores one branch deeply before backtracking to explore other branches. This algorithm allows for a thorough examination of each potential solution path, making the algorithm useful for problems requiring detailed exploration of each option. For example, in solving a complex code generation task, DFS would follow a single hypothesis deeply, checking its validity before considering alternatives.

By integrating these components, the ToT framework mimics human problem-solving by systematically considering multiple solutions and discarding the ones that are found incorrect.

In at least some embodiments, the activity of the multiple coding agents can be reviewed, modified, and/or approved by a voting module 214, which can be implemented as part of LLM engine 202, as part of the implementation of the ToT framework, by initiating and engaging a separate voting agent (which is an AI agent that works with a generative machine learning model to perform code-related tasks such as code evaluation), and/or with supplemental software code. For example, voting module 214 may select one of multiple proposed versions of workflow code generated by the coding agents of workflow code generator 212 as an executable version of the workflow code. Voting module 214 may alternatively or additionally direct revisions of one or more proposed versions of workflow code by workflow code generator 212. As indicated by dashed line illustration, the determinations made by voting module 214 may take into account user input, for example, natural language textual input received from a user interacting with a user interface presented at the end user device 103. In some embodiments, voting module 214 may implement multiple independent voting agents. These voting agents can be, for example, simulated subject matter experts in the given field of endeavor. In one embodiment, the voting module 214 performs a selection of one of the multiple versions of workflow code, e.g., by choosing the version which one voting agent rates as the best version. In other embodiments, the voting module 214 performs a vote by having multiple agents select and/or score the multiple versions of workflow code and by aggregating the selections and/or scores to find a best version of the workflow code.

Ensuring independent evaluation by the multiple voting agents is helpful. The present embodiments achieve independent evaluation by incorporating one, some, or all of the following techniques:
Model Independence: Each voting agent can be instantiated using different underlying LLM models or differently trained variations of a base model. This use of differences prevents a single model from fabricating consensus.
Decoupled Decision Processes: Each voting agent operates on separate computational instances, avoiding shared context leakage. Their evaluations are performed independently before aggregation.
Diversity in Training and Prompting: Different voting agents may use specialized models trained on distinct datasets (e.g., security-focused code review vs. performance optimization). Alternatively, variations in prompting strategies can ensure diverse perspectives even within the same base model.
Cryptographic or Statistical Verification: Techniques such as hash-based verification or ensemble averaging can detect collusion or self-reinforcing biases among agents.

In the illustrated example, synthetic data generation tool 200 additionally includes a workflow executor 216 configured to execute the executable version of the workflow code selected by voting module 214. In various embodiments, workflow executor 216 can be implemented as part of LLM engine 202 and/or with supplemental software code. Workflow executor 216, through execution of the workflow code, generates synthetic data 218, which can, for example, be stored in one or more database tables or other data structures in a format specified by the prompt.

Although FIG. 2 illustrates a unitary LLM engine 202 as forming a component of synthetic data generation tool 200, those skilled in the art will appreciate that, in some embodiments, LLM engine 202 may include multiple communicatively coupled LLMs, including a private LLM, a subscription-based LLM, and/or a publicly available LLM, such as those available over the Internet. In at least some embodiments in which LLM engine 202 includes multiple LLMs, workflow prompt builder 210 and workflow code generator 212 can be implemented in a private or subscription-based (restricted access) LLM, and workflow executor 214 can be implemented in a publicly available LLM.

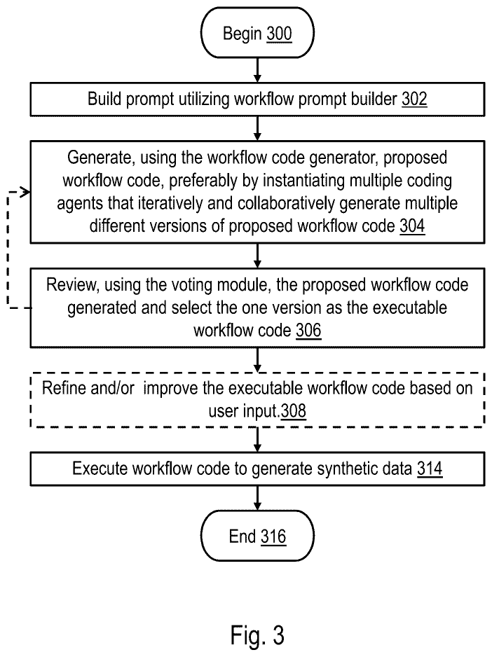

With reference now to FIG. 3, there is illustrated a high-level logical flowchart of an exemplary process for generating synthetic data in accordance with one or more embodiments. The illustrated process can be performed, for example, through the execution of synthetic data generation code 200 by processor set 110 of computer 101 of FIG. 1A.

The process of FIG. 3 begins at block 300 and then proceeds to block 302, which illustrates workflow prompt builder 302 building a prompt to cause LLM engine 202 to build a suitable synthetic dataset. As indicated above, the construction of the prompt by workflow prompt builder 210 can be initiated based on an input received from an end user device 103. For example, a user engages with a user interface displayed at the end user device 103 in order to initiate the process of FIG. 3 and more specifically to initiate the building of the prompt by the workflow prompt builder 210. In at least some embodiments, the prompt may include multiple elements, including some or all of a workflow context, one or more workflow APIs, metadata that is relevant to the data to be generated, one or more data rules, e.g., business rules, and one or more workflow code parameters. The workflow context can specify, for example, specific requirements of the workflow code, such as the amount of synthetic data to be generated (e.g., 106 data elements), the domain of the synthetic data (e.g., medical data, banking data, meteorological data, etc.), and any industry-related information. The workflow APIs element of the prompt can designate APIs that can be called by workflow executor 214 to generate synthetic data. Workflow APIs can be employed by LLM engine 202 because the raw real-world data and associated table schemas often cannot be directly accessed by LLM 202. The one or more business rules enumerated by the prompt can define domain-specific terms and/or specify relationships between data elements (e.g., city and province/region columns in a postal address dataset). The workflow code parameters can specify, for example, the format of the workflow code that is to be generated by workflow code generator 212 (e.g., Python).

An example of a workflow prompt can be expressed in natural language text as follows:
Suppose you are a workflow generator, and your task is to generate workflow code that can be used to generate at least 100,000 pieces of synthetic data based on the input message.
The general functions that can be used are:
   get_table_schema(table_name): Return the table schema of the input table
   get_sample_data(table_name): Return ten rows of the input table
   get_foreign_key(table1, table2): Return the foreign key of the tables
Apply the following business rules:
1. Output should be in csv.
2. The columns Product and Sub_product should have unique combination.
3. Transaction amounts should be between 10 and 10000 US dollars.
4 Product column should be in [‘bank_account’, ‘credit_card’]; Sub_product column should be in [‘checking account’, ‘saving account’, ‘other account service’]
Three experts with exceptional logical thinking skills are to work collaboratively to generate the synthetic data using a tree of thoughts method. Each expert will share with the others its thought process in detail, taking into account the previous thoughts of others and admitting any errors. The experts will iteratively refine and expand upon each other's ideas, giving credit where due. The process will continue iteratively until a good workflow is generated. Please write Python code with modularization and commenting, and use the input message to generate the workflow of the task. Organize the entire response in a markdown table format.

Following block 302, the process of FIG. 3 proceeds to block 304, which illustrates workflow code generator 212 generating at least one version of proposed workflow code. As noted above, in at least some embodiments the prompt constructed by workflow prompt builder 210 is input into the workflow code generator 212 so as to cause workflow code generator 212 to instantiate multiple coding agents that simulate multiple experts that iteratively and collaboratively generate workflow code. These coding agents can critique each other's workflow code utilizing natural language feedback. The use of the natural language feedback enables collaboration and iterative improvement. In at least some embodiments, workflow code generator 212 employs multiple tree-of-thoughts (TOT) pipelines to concurrently generate different proposed versions of the workflow code. If the workflow APIs specified in the workflow prompt do not include functions that can implement the required logic, workflow code generator 212 will also generate new APIs that can be invoked to implement the workflow logic.

At block 306, voting module 214 reviews the proposed workflow code generated by workflow code generator 212 and selects one version of the proposed workflow code as executable workflow code to be executed by workflow executor 216. In at least some embodiments, voting module 214 instantiates multiple independent reviewing agents that independently review and rank multiple versions of the workflow code, selecting the proposed workflow code having the highest overall ranking as the executable workflow code. An example of a natural language input to cause LLM engine 202 to form an exemplary voting module 214 can be given as follows:
Suppose there are ten reviewing agents, all of whom are code generation professionals and have a clear understanding of business processes and data in the financial industry. In order to obtain a batch of synthetic data, we asked three coding agents to write synthetic data generation workflow code, but the rationality and correctness of the code generated by the three experts need to be evaluated and voted on by the reviewing agents to determine the final result.
Coding Agent 1: . . . //proposed workflow code version 1
Coding Agent 2: . . . //proposed workflow code version 2
Coding Agent 3: . . . //proposed workflow code version 3
Business logic for generating data is as follows: . . . //exemplary business logic
Each reviewing agent should evaluate and score the above workflow code versions and provide the overall results.

Based on this input, voting module 214 may generate a voting report summarizing in natural language text the evaluation of the proposed workflow code by the reviewing agents and the overall result of the evaluation. As one example, voting module 214 may provide a voting report such as:
Reviewer 1: I think the result generated by Coding Agent 1 is more accurate and version 3 generated by Coding Agent 3 seems to be wrong. The processing flow generated by Coding Agent 2 contains logical errors.
Reviewer 2: I think the result generated by Coding Agent 1 is correct; the processes of Coding Agents 2 and 3 are too long.
Reviewer 3: Version 2 of Coding Agent 2 produces the best results because . . .
Reviewer 10: The code generated by Coding Agent 2 does not follow the requirements of business logic 1, and the results generated by Coding Agent 3 conflict with business logic 2, so the results of Coding Agent 1 are better.
In summary, the voting results are as follows:
Coding Agent 1:5 votes
Coding Agent 2:3 votes
Coding Agent 3:2 Votes

As indicated by dashed line illustration in FIG. 3, in some embodiments or use cases the results output by voting module 214 can cause workflow code generator 212 to further refine and/or correct the version of the workflow code selected by voting module 214. For example, the correction may update the selected version of the workflow code to better comply with a business rule stipulated in the prompt. For example, an AI prompt builder accepts the voting results and corresponding comments as input and generates a new natural language workflow prompt with instructions for revising one or more of the versions of the workflow code.

FIG. 3 further illustrates at optional block 308 that LLM engine 202 may additionally refine and/or correct the version of the workflow code selected by voting module 214 based on user input received, for example, via end user device 103. For example, in one embodiment, voting module 214 may provide to end user device 103 a workflow code digest, including a natural language textual high-level description of the selected version of the workflow code. One example of a workflow code digest can be given as follows:
This workflow generates synthetic data for a banking provider. The process involves the following steps:
1. **Define Schemas: ** Retrieve table schemas for ‘product’ and ‘transactions’ using the ‘get_table_schema’ function.
2. **Generate Unique Product Combinations: ** Create synthetic product data ensuring each value is unique combinations of ‘product’ and ‘sub_product’ using the ‘generate_unique_combinations’ function.
3. **Generate Transaction Data: ** For each unique product, generate multiple transactions with ‘amount’ values between 10 and 10000 dollars.
4. **Output to CSV: ** Save the generated product and transaction data to CSV files using the ‘output_to_csv’ function.
The synthetic data generation ensures adherence to specified business rules, including unique product-sub_product combinations and valid transaction amounts.

Based on the workflow code digest, the user can in some embodiments provide LLM engine 202 additional natural language textual input to refine and/or to correct the selected version of the workflow code. For example, in one use case the user can provide the following user input:
The concept of unique combinations of products is incorrect here. Unique means that the pairings of the product column and the sub_product column are fixed. For example, product ‘a’ can only be paired with sub_product ‘11’ and ‘22’.

Based on this user input, workflow code generator 212 can further refine and/or correct the version of the workflow code selected by voting module 214. At the conclusion of block 308 if implemented, or at the conclusion of block 306 if block 308 is omitted, voting module 214 provides executable workflow code to workflow executor 216. As indicated at block 314, workflow executor 216 executes the executable workflow code to generate the dataset of synthetic data 218. In at least some embodiments, workflow executor 216 is capable of executing workflow code expressed in multiple different programming and/or scripting languages. The process of FIG. 3 thereafter ends at block 316.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks, and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants (like IBM watsonx Assistant and Google's BARD) to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks, and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

As has been described, in one or more embodiments of a computer-implemented technique of synthetic data generation, natural language workflow prompt is generated that includes instructions to generate multiple versions of workflow code for generating synthetic data. The generated workflow prompt is inputted into a generative machine learning model such that, in response, the generative machine learning model produces multiple versions of the workflow code for generating synthetic data. Multiple versions of the workflow code are inputted into at least one evaluator machine learning model such that, in response, the at least one evaluator machine learning model selects one of the multiple versions of the workflow code. Synthetic data is generated by executing the selected workflow code and stored in data storage.

While the present invention has been particularly shown as described with reference to one or more preferred embodiments, it will be understood by those skilled in the art that various changes in form and detail may be made therein without departing from the spirit and scope of the invention.

The following definitions are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, system, or apparatus that comprises a list of elements is not necessarily limited to only those elements but can include other elements not expressly listed or inherent to such composition, mixture, process, method, article, system, or apparatus.

Additionally, the term “exemplary” is used herein to mean “serving as one example, instance or illustration.” Any embodiment or design described herein as “exemplary” is not necessarily to be construed as preferred or advantageous over other embodiments or designs. The terms “at least one” and “one or more” shall be understood to include any integer number greater than or equal to one, and the term “plurality” shall be understood to include any integer number greater than or equal to two. The term “coupled” shall include both indirect connection and a direct connection, unless specified otherwise in a particular case. The terms “about,” “substantially,” “approximately,” and variations thereof, are intended to include the degree of error associated with measurement of the particular quantity based upon the equipment available at the time of filing the application. For example, “about” can include a range of ±10% or ±5%, or ±2% of a given value.

The figures described herein and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. For the sake of brevity, conventional techniques related to making and using aspects of the invention(s) may or may not be described in detail herein, and many conventional implementation details are only mentioned briefly or are omitted entirely. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A method comprising:
generating a natural language workflow prompt, wherein the workflow prompt comprises instructions to generate multiple versions of workflow code for generating synthetic data;
inputting the generated workflow prompt into a generative machine learning model such that, in response, the generative machine learning model produces the multiple versions of the workflow code for generating synthetic data, wherein the generative machine learning model has been trained to perform code-related tasks;
inputting the multiple versions of the workflow code into at least one evaluator machine learning model such that, in response, the at least one evaluator machine learning model selects one of the multiple versions of the workflow code, wherein the at least one evaluator machine learning model has been trained to perform code-related tasks;
generating synthetic data by executing the selected workflow code; and
storing the generated synthetic data in data storage.

2. The method of claim 1, wherein the generative machine learning model implements a tree of thoughts pipeline to produce the multiple versions of the workflow code.

3. The method of claim 1, wherein the generative machine learning model instantiates multiple artificial intelligence coding agents to produce the multiple versions of the workflow code, wherein each of the coding agents produces a respective one of the multiple versions of the workflow code.

4. The method of claim 1, wherein the at least one evaluator machine learning model instantiates multiple artificial intelligence voting agents to select the one of the multiple versions of the workflow code, wherein the selecting comprises the multiple voting agents voting on the multiple versions of the workflow code.

5. The method of claim 1, further comprising:
presenting a natural language workflow digest via an end user device; and
based on a natural language user input responsive to the workflow digest, refining one of the multiple versions of the workflow code to obtain the executable workflow code.

6. The method of claim 1, wherein the natural language workflow prompt specifies at least one member selected from a group consisting of: at least one workflow application programming interface (API), at least one data rule for the synthetic data, metadata of real-world data which the synthetic data is to mimic, and workflow code parameters.

7. The method of claim 1, wherein the generative machine learning model implements a three-of-thought pipeline to produce the multiple versions of the workflow code, and wherein the at least one evaluator machine learning model is part of the three-of-thought pipeline.

8. A computer program product, comprising:
one or more computer-readable storage media; and
program instructions stored on the one or more computer-readable storage media to perform operations including:
generating a natural language workflow prompt, wherein the workflow prompt comprises instructions to generate multiple versions of workflow code for generating synthetic data;
inputting the generated workflow prompt into a generative machine learning model such that, in response, the generative machine learning model produces the multiple versions of the workflow code for generating synthetic data, wherein the generative machine learning model has been trained to perform code-related tasks;
inputting the multiple versions of the workflow code into at least one evaluator machine learning model such that, in response, the at least one evaluator machine learning model selects one of the multiple versions of the workflow code, wherein the at least one evaluator machine learning model has been trained to perform code-related tasks;
generating synthetic data by executing the selected workflow code; and
storing the generated synthetic data in data storage.

9. The computer program product of claim 8, wherein the generative machine learning model implements a tree of thoughts pipeline to produce the multiple versions of the workflow code.

10. The computer program product of claim 8, wherein the generative machine learning model instantiates multiple artificial intelligence coding agents to produce the multiple versions of the workflow code, wherein each of the coding agents produces a respective one of the multiple versions of the workflow code.

11. The computer program product of claim 8, wherein the at least one evaluator machine learning model instantiates multiple artificial intelligence voting agents to select the one of the multiple versions of the workflow code, wherein the selecting comprises the multiple voting agents voting on the multiple versions of the workflow code.

12. The computer program product of claim 8, wherein the operations further include:
presenting a natural language workflow digest via an end user device; and
based on a natural language user input responsive to the workflow digest, refining one of the multiple versions of the workflow code to obtain the executable workflow code.

13. The computer program product of claim 8, wherein the natural language workflow prompt specifies at least one member selected from a group consisting of: at least one workflow application programming interface (API), at least one data rule for the synthetic data, metadata of real-world data which the synthetic data is to mimic, and workflow code parameters.

14. The computer program product of claim 8, wherein the generative machine learning model implements a three-of-thought pipeline to produce the multiple versions of the workflow code, and wherein the at least one evaluator machine learning model is part of the three-of-thought pipeline.

15. A computer system, comprising:
a processor set;
one or more computer-readable storage media; and
program instructions stored on the one or more computer-readable storage media to cause the processor set to perform operations including:
generating a natural language workflow prompt, wherein the workflow prompt comprises instructions to generate multiple versions of workflow code for generating synthetic data;
inputting the generated workflow prompt into a generative machine learning model such that, in response, the generative machine learning model produces the multiple versions of the workflow code for generating synthetic data, wherein the generative machine learning model has been trained to perform code-related tasks;
inputting the multiple versions of the workflow code into at least one evaluator machine learning model such that, in response, the at least one evaluator machine learning model selects one of the multiple versions of the workflow code, wherein the at least one evaluator machine learning model has been trained to perform code-related tasks;
generating synthetic data by executing the selected workflow code; and
storing the generated synthetic data in data storage.

16. The computer system of claim 15, wherein the generative machine learning model implements a tree of thoughts pipeline to produce the multiple versions of the workflow code.

17. The computer system of claim 15, wherein the generative machine learning model instantiates multiple artificial intelligence coding agents to produce the multiple versions of the workflow code, wherein each of the coding agents produces a respective one of the multiple versions of the workflow code.

18. The computer system of claim 15, wherein the at least one evaluator machine learning model instantiates multiple artificial intelligence voting agents to select the one of the multiple versions of the workflow code, wherein the selecting comprises the multiple voting agents voting on the multiple versions of the workflow code.

19. The computer system of claim 15, wherein the operations further include:
presenting a natural language workflow digest via an end user device; and
based on a natural language user input responsive to the workflow digest, refining one of the multiple versions of the workflow code to obtain the executable workflow code.

20. The computer system of claim 15, wherein the natural language workflow prompt specifies at least one member selected from a group consisting of: at least one workflow application programming interface (API), at least one data rule for the synthetic data, metadata of real-world data which the synthetic data is to mimic, and workflow code parameters.
